(19) United States
(12) Patent Application Publication
(10) Pub. No.: US 2015/0175428 A1
(43) Pub. Date: Jun. 25, 2015

(54) DEVICE AND METHOD FOR GENERATING DRY ICE SNOW

(71) Applicant: Rolf Heninger, Hohenkirchen-Siegertsbrunn (DE)

(72) Inventor: Rolf Heninger, Hohenkirchen-Siegertsbrunn (DE)

(21) Appl. No.: 14/547,613

(22) Filed: Nov. 19, 2014

(30) Foreign Application Priority Data
Dec. 20, 2013 (EP) 13005991.8

(51) Int. Cl. C01B 31/22; F25D 3/12

(52) U.S. Cl. CPC C01B 31/22; F25D 3/12

(57) ABSTRACT

A device for generating dry ice snow having a rotating body mounted in a housing to rotate around a rotational axis, exhibiting at least one expansion chamber on the circumference of the rotating body, a feed line for introducing liquid carbon dioxide into the at least one expansion chamber, the housing having an inlet opening for introducing a gaseous mass flow into the at least one expansion chamber, and an outlet opening for dispensing the dry ice snow generated in the respective expansion chamber from the housing. The inlet and outlet openings are arranged such that the at least one expansion chamber can be simultaneously connected with the inlet and outlet openings in terms of flow by rotating the rotating body around the rotational axis, so that at least sections of the at least one expansion chamber can carry a gaseous mass flow along the rotational axis.

### CROSS REFERENCE TO RELATED APPLICATIONS

The present application claims priority from European Patent Application EP 13005991.8 filed Dec. 20, 2013.

### BACKGROUND OF THE INVENTION

The invention relates to a device for generating dry ice snow, in particular in the form of individual dry ice packets, as well as to a corresponding method, in particular for cleaning surfaces.

One way to efficiently clean surfaces is to blast them with dry ice generated beforehand. Dry ice is carbon dioxide transformed into the solid phase and cooled to at least −78.5° C. Dry ice passes directly from a solid into a gaseous phase under atmospheric pressure, with no melted liquid forming. This makes it especially easy to blast with dry ice and to vacuum and remove dirt particles, specifically using normal compressed air.

Dry ice is present in the form of snow during production. Generating CO₂ snow on site by means of a liquid CO₂ nozzle and directly blasting a surface with this snow, if necessary assisted by compressed air, is a comparatively easy process that can be readily automated.

Above all two main tasks arise when generating and dispensing such dry ice packets, specifically the requirement that the packets be large and compact enough, and that the device for generating can operate continuously, i.e., it must not get jammed by any dry ice remaining in the device.

Known from EP 2 163 518 A1 in this regard, for example, is a device exhibiting a rotating body mounted in a housing so that it can rotate around a rotational axis, wherein the rotating body exhibits expansion chambers. The latter are charged with liquid carbon dioxide via a feed line, wherein dry ice generated in the expansion chambers is dispensed from the chambers and accelerated onto a surface so as to clean it.

The axis of the rotating body here runs transverse to the flowing direction of the compressed air stream with which the generated dry ice packets are to be accelerated. This configuration is based upon the fact that the dry ice is hurled out of the individual expansion chambers of the rotating body by a rotationally induced centrifugal force, wherein compressed air is additionally blown into the cells to remove any residual dry ice from the cells. However, it was shown that the generated centrifugal force or compressed air blown into the expansion chambers perpendicular to the rotational axis is routinely inadequate for reliably ridding the expansion chambers of residual dry ice.

Therefore, proceeding from the above, the object of the present invention is to provide a device and method of the kind mentioned at the outset that ameliorate the aforesaid problem,

### SUMMARY OF THE INVENTION

The latter provide that the inlet opening and outlet opening be arranged in such a way that the at least one expansion chamber can be simultaneously connected with the inlet opening and outlet opening in terms of flow by rotating the rotating body around the rotational axis, wherein at least one section of the at least one expansion chamber (preferably the entire expansion chamber) extending along the rotational axis is arranged between the inlet opening and outlet opening, so that the at least one expansion chamber can carry a mass flow introduced through the inlet opening at least in sections (preferably completely) along the rotational axis.

For example, along the rotational axis here means that the expansion chamber extends parallel to the rotational axis, or even at a certain inclination relative to the rotational axis (e.g., when the rotating body/hub shell is shaped like a cone or truncated cone, see below). The at least one expansion chamber preferably extends along an extension direction, specifically in particular elongated (i.e., the expansion of the at least one expansion chamber or all present expansion chambers is greater in the extension direction than transverse to the extension direction), wherein the extension direction runs parallel to the rotational axis, or at a certain inclination relative to the rotational axis (preferably including an angle with the rotational axis that is at least acute, preferably less than or equal to 70°, 60°, 50° or 45°).

The respective expansion chamber preferably exhibits a first end section that is joined with a second end section of the respective expansion chamber via a central section along the extension direction of the respective expansion chamber, wherein the two end sections lie opposite each other along the extension direction. The device is preferably designed in such a way that, by rotating the rotating body, the first end section of the respective expansion chamber can be connected in terms of flow with the inlet opening, and its second end section can be connected in terms of flow with the outlet opening. As a consequence, the gaseous mass flow can reliably pass through the respective expansion chamber, cleaning it out in the process.

In addition, the at least one inlet opening can be located on a first side (e.g., a rear side) of the rotating body, e.g., which extends transverse to the rotational axis, wherein the outlet opening can be located on a second side (e.g., a front side) of the rotating body, which lies opposite the first side along the rotational axis. The second side can also involve a side of the rotating body running along the circumference when the latter exhibits an inclination relative to the first side.

The flow according to the invention passing through the at least one expansion chamber along the rotational axis allows the gaseous mass flow introduced into the at least one expansion chamber via the inlet opening to entrain essentially all of the dry ice snow generated in the respective expansion, and dispense it from the housing through the outlet opening.

It is preferably provided that the device exhibit several partitioned expansion chambers, which each preferably extend continuously along the rotational axis from the rear side of the rotating body to the front side of the rotating body. The expansion chambers can be partitioned (e.g., by wings projecting from a hub shell of the rotating body) in a solid way, i.e., imperviously to gas, but can also consist of a gas-permeable material or a solid material that incorporates gas-permeable openings or pores. In a special embodiment, these openings are incorporated as fine slits resembling a comb.

It is further preferably provided that the inlet opening and outlet opening be arranged in such a way that the at least one or each expansion chamber is simultaneously connected in terms of flow with the inlet opening and outlet opening once per revolution by the rotating body around the rotational axis.

It is further preferably provided that the diameter of the rotating body perpendicular to the rotational axis range from 20 mm to 100 mm.

In a preferred embodiment of the invention, the device exhibits a channel connected in terms of flow with the inlet opening for supplying the gaseous mass flow, wherein at least one section of the channel exhibiting the net opening or the entire channel extends along the rotational axis, in particular parallel to the rotational axis.

Further provided according to a preferred embodiment is that the rotating body and/or the at least one expansion chamber or the several expansion chambers taper along the rotational axis, in particular in the streaming direction of the gaseous mass flow, wherein in particular the rotating body has a conical design. Alternatively hereto, the rotating body can be cylindrical in design. A taper can also be achieved by having the hub she of the rotating body be designed like a cone or truncated cone, with a diameter that rises in the streaming direction of the gaseous mass flow, i.e., toward the outlet opening, while the rotating body itself can be cylindrical in design as concerns its contour.

The device preferably exhibits a Laval nozzle for accelerating the dry ice snow packets. The outlet opening can here be connected in terms of flow with the Laval nozzle. Alternatively hereto, at least sections of the Laval nozzle can be formed by the respective expansion chambers connected in terms of flow with the outlet opening, and exhibit a nozzle section that adjoins the at least one outlet opening and whose cross section expands once again. The outlet opening of the housing is then situated on roughly the neck of the nozzle.

Another preferred embodiment of the invention provides that the channel branches from an additional channel of the device that preferably extends along the rotational axis and in particular runs parallel to the rotational axis or parallel to the one channel, wherein the outlet opening empties into the additional channel, and wherein the additional channel empties into said Laval nozzle.

In order to drive the rotating body, the device can exhibit a motor, e.g., which can be designed as a compressed air motor. The compressed air motor can here be coupled via a gear reduction with a drive axle of the rotating body that coincides with the rotational axis. Alternatively hereto, the motor can be designed as an electric motor, whose speed can be controlled via the current intensity of the applied supply voltage, for example.

Another preferred embodiment provides that the device be designed to be driven by the same gaseous mass flow also used to accelerate the generated dry ice snow, wherein the device for driving the rotating body with said mass flow preferably exhibits a turbine coupled with the drive axle of the rotating body, wherein in particular the turbine can be coupled with the drive axle of the rotating body either directly or via a reduction gear.

It is preferably further provided that the at least one expansion chamber or several expansion chambers of the rotating body be bounded by wings projecting in a radial direction from a hub she of the rotating body, by means of which the rotating body is coupled with the drive axle. The wings preferably are inclined relative to the rotational axis, so that in particular the rotating body is driven by the gaseous mass flow, or the motor of the device is supported by the gaseous mass flow as it passes through the at least one expansion chamber or one of the several expansion chambers along the rotational axis.

It is further preferably provided that the feed line for the liquid CO₂ be connected in terms of flow with at least one inlet opening of the housing, which is situated in such a way, in particular on the first side or rear side of the rotating body, that the at least one or each expansion chamber can be connected in terms of flow with the at least one inlet opening by rotating the rotating body around the rotational axis, specifically in particular once per revolution by the rotating body around the rotational axis, so that liquid CO₂ can be introduced into the respective expansion chamber connected in terms of flow with the at least one inlet opening, wherein in particular the at least one inlet opening is arranged in such a way that liquid CO₂ introduced into the respective expansion chamber for generating dry ice can remain in the respective expansion chamber for at least half a revolution, preferably at least for three fourths of a revolution by the rotating body around the rotational axis before being dispensed from the expansion chamber through the outlet opening or the respective expansion chamber becomes connected in terms of flow with the outlet opening.

The CO₂ feed line and at least one inlet opening are preferably configured in such a way that liquid CO₂ can be introduced in a streaming direction into the respective expansion chamber connected in terms of flow with the inlet opening, wherein in particular the streaming direction runs along the rotational axis, especially parallel to the rotational axis, or exhibits a component transverse to the rotational axis (e.g., a tangential component relative to the circumference of the rotating body), so that in particular the rotating body can additionally be driven by the expanding CO₂.

The problem underlying the invention is also resolved by a method using a device as described herein in which the liquid carbon dioxide is introduced into at least one expansion chamber of a rotating body and expands in the process, so that dry ice snow is generated in the at least one rotation chamber, wherein the at least one rotating body is rotated around a rotational axis, and wherein the at least one expansion chamber is arranged on the circumference of the rotating body, and extends in particular continuously along the rotational axis, and wherein a gaseous mass flow is introduced into the at least one rotation chamber, in particular in the form of compressed air, so that the mass flow streams through the at least one expansion chamber at least in sections along the rotational axis, during which the dry ice snow generated in the at least one expansion chamber is entrained and ejected out of the at least one expansion chamber along the rotational axis, in particular onto a surface to be cleaned.

According to the latter, the method according to the invention exhibits features in which liquid carbon dioxide is introduced into at least one (or more) expansion chamber(s) of a rotating body and expands in the process, so that dry ice snow is generated in the at least one rotating chamber, in particular in the form of a dry ice snow packet, wherein the at least one rotating body is rotated around a rotational axis, and wherein the at least one expansion chamber is arranged on the circumference of the rotating body, and extends continuously along the rotational axis, and wherein a gaseous mass flow is introduced into the at least one rotation chamber, in particular in the form of compressed air, so that the mass flow streams through the at least one expansion chamber at least in sections, preferably completely, along the rotational axis, during which the dry ice snow generated in the at least one expansion chamber is entrained and ejected out of the at least one expansion chamber along the rotational axis (e.g., onto a surface to be cleaned). Of course, several expansion chambers can be used as well (e.g., see above).

The liquid carbon dioxide is preferably introduced (in particular sequentially) into the at least one or several partitioned expansion chambers of the rotating body and there expanded, thereby giving rise to a dry ice snow packet in the respective expansion chamber, wherein these expansion chambers each extend continuously along the rotational axis from the first side or rear side of the rotating body toward the second side or front side of the rotating body.

In addition, a gaseous mass flow is preferably introduced into each expansion chamber (in particular charged with dry ice snow) once per revolution by the rotating body around the rotational axis, so that the mass flow flows through the at least one expansion chamber at least in sections, preferably completely, along the rotational axis, during which the dry ice snow generated in the respective expansion chamber is entrained and ejected out of the respective expansion chamber along the rotational axis.

The dry ice snow generated in packets is preferably dispensed from the respective expansion chamber via a Laval nozzle.

In another variant of the method according to the invention, the gaseous mass flow is divided into a first and second partial flow, wherein the first partial flow is guided through the respective expansion chamber along the rotational axis to eject dry ice snow that was generated there out of the respective expansion chamber along the rotational axis, and wherein the second partial flow is guided by the rotating body along the rotational axis, and wherein the dry ice snow ejected out of the respective expansion chamber along the rotational axis along with the first partial flow downstream from the respective expansion chamber is combined with the second partial flow and dispensed through the Laval nozzle.

The rotating body is preferably driven by means of a motor (see above) and/or by means of the gaseous mass flow. The rotating body in the method according to the invention is preferably made to rotate at a speed ranging from 20 to 200 revolutions per minute, preferably 40 to 100 revolutions per minute.

It is further preferred that the expansion chambers be charged with liquid CO₂ in an amount ranging from 0.05 to 1.0 g/cm³, preferably 0.1 to 0.7 g/cm³, especially preferably 0.2 to 0.4 g/cm³, per revolution.

The liquid CO₂ is preferably introduced into the respective expansion chamber in such a way that dry ice snow arising therein is dispensed by the gaseous mass flow only after at least half a revolution, preferably only after three fourths of a revolution by the respective expansion chamber around the rotational axis,

Liquid carbon dioxide can also be introduced and expanded in various expansion chambers via several feed points (e.g., inlet openings, see above), in particular simultaneously.

In addition, the liquid carbon dioxide can further be introduced into the respective expansion chamber in such a way as to support or additionally drive the rotation of the rotating body (see above).

It is especially preferable that the gaseous mass flow provided in the method according to the invention be compressed air.

### BRIEF DESCRIPTION OF THE DRAWINGS

Additional features and advantages of the invention will be explained by describing exemplary embodiments based on the figures. Shown on:

FIG. 1 is a schematic sectional view of a device according to the invention for generating and dispensing dry ice snow packets.

FIG. 2 is a schematic sectional view along the II-II line on FIG. 1.

FIG. 3 is a schematic sectional view depicting a modification of the device according to the invention depicted on FIG. 1, wherein only part of the compressed air is guided through the expansion chambers.

FIG. 4 is a schematic sectional view of another device according to the invention, which is driven by a compressed air motor.

FIG. 5 is a schematic sectional view of another device according to the invention, in which a section of a Laval nozzle is integrated into the rotating body.

FIG. 6 is a schematic sectional view of another device according to the invention with a rotating body shaped like a truncated cone.

### DETAILED DESCRIPTION OF THE INVENTION

In conjunction with FIG. 1, FIG. 1 shows a device 1 according to the invention for generating and dispensing dry ice snow packets.

The device 1 exhibits a housing 20, which incorporates a rotating body 10 so that it can rotate around a rotational axis R, wherein the rotating body 10 exhibits a plurality of expansion chambers 13 along a circumference of the rotating body 10 that circles the rotational axis R, which each extend continuously along the rotational axis R from a first side or rear side 10b of the rotating body 10 extending transverse to the rotational axis R to a second side or front side 10a of the rotating body 10 facing away from the first side/rear side 10b.

The rotating body 10 exhibits a plurality of wings 12 that project in a radial direction R″ from a hub shell 11 of the rotating body 10, wherein a respective two adjacent, opposing wings 12 of the rotating body 10 together with a continuous wall 24 of the housing 20 form an expansion chamber 13 of the device 1, into which liquid carbon dioxide can be introduced, so that the liquid carbon dioxide is converted into a dry ice snow packet T via expansion in the respective expansion chamber 13.

In order to eject the dry ice snow T generated in the respective expansion chamber 13 out of the latter, the device 1 according to the embodiments shown on FIGS. 1, 4, 5 and 6 exhibits a channel 30 that extends along the rotational axis R and empties into an inlet opening 21 of the housing 20, through which a gaseous mass flow D can be introduced, preferably in the form of compressed air D, into the respective expansion chamber 13 of the rotating body 10 when the latter becomes connected in terms of flow with the inlet opening 21 of the housing 20 as the rotating body 10 rotates around the rotational axis R. The compressed air D then streams completely or almost completely through the respective expansion chamber 13 along the rotational axis R, thereby entraining the dry ice snow packet T located in the respective expansion chamber 13, and conveys it through an outlet opening 22 of the housing 20 and out of the device 1. The plurality of expansion chambers 13 for the turning rotating body 10 makes it possible to dispense a quasi-continuous stream of dry ice snow packets T with the device 1 and, for example, fire them onto a surface to clean the latter.

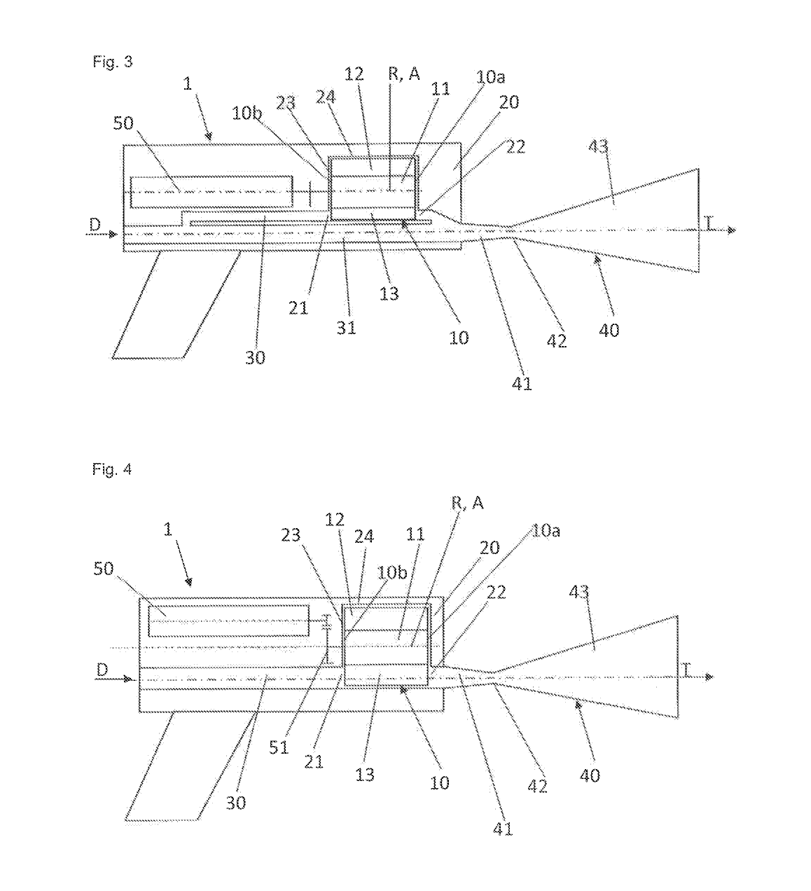

On FIGS. 1, 3 and 4, said outlet opening 22 is preferably adjoined by a Laval nozzle 40, which exhibits a tapering first nozzle section 41, which continuously tapers in cross section toward a nozzle neck 42, wherein a second nozzle section 43 with a growing cross section follows the nozzle neck 42. The dry ice snow batches generated in the individual expansion chambers 13 are accelerated through this Laval nozzle 40. According to the invention, the entire compressed air stream D can here be passed through the respective expansion chamber 13, and entrain the dry ice packet T situated therein through the Laval nozzle. As shown on FIG. 3, however, it is also possible to pass only a portion of the compressed air D through the respective expansion chamber 13 aligning with the inlet opening 21.

For this purpose, the device 1 in the embodiment according to FIG. 3 exhibits an additional channel 31 that extends along the rotational axis R and empties into aforesaid Laval nozzle 40, wherein the aforesaid one channel 30 branches off the additional channel 31 upstream from the rotating body 10 and leads to aforesaid inlet opening 21, so that a portion of the available compressed air D passes from the additional channel 31 into the aforesaid one channel 30, and from there can be passed through the respective expansion chamber 13 that currently aligns with the inlet opening 21. In this case, the outlet opening 22 of the housing 20 empties into the additional channel 31 downstream from the rotating body 10, so that the two partial compressed air streams can again be combined with the dry ice, and dispensed from the device 1 via the aforesaid Laval nozzle 40.

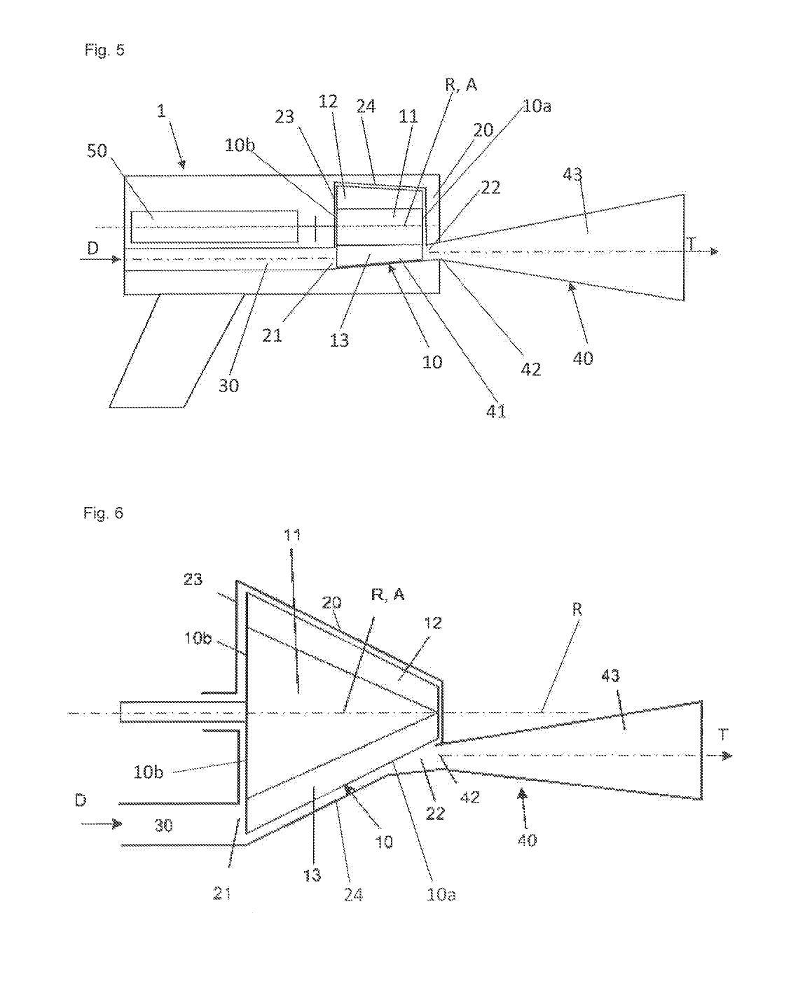

In the exemplary embodiment shown on FIG. 5, the rotating body 10 can additionally be conically tapered along the rotational axis R, specifically in the streaming direction of the dry ice snow or compressed air stream D, so that the individual expansion chambers 10 also taper conically along the aforesaid streaming direction (the hub shell 11 is here cylindrical in design), the advantage to which is that the first nozzle section 41 of the Laval nozzle 40 described above is now formed (if necessary up until the nozzle neck 42) by the respective expansion chamber 13 communicating with the channel, which permits a shortened configuration of the device 1 according to the invention along the rotational axis R. The same can be realized for the embodiment according to FIG. 6.

Alternatively, the rotating body 10 can be cylindrical in design on the outer circumference, while the hub shell 11 can be conical in design with a diameter that increases in direction 22, which also results in a tapering of the expansion chamber 10.

FIG. 6 shows an additional embodiment of the invention, in which the hub shell 11 designed as a cone (or alternatively a truncated cone), wherein the wings 12 project from the hub shell 11 in such a way that the entire rotating body 10 assumes the form of a truncated cone. The rotating body 10 or hub shell 11 here tapers essentially in the streaming direction of the gaseous mass flow or compressed air D. The pronounced tapering of the rotating body 10 now causes the outlet opening 22 to be situated on a continuous second side of the rotating body 10 or on the continuous wall 24 of the housing 20, which opposes a first side or rear side 10b of the rotating body 10 along the rotational axis R. Therefore, the gaseous mass flow D can stream through a large portion of the respective expansion chamber 13 from the inlet opening 21 up to the outlet opening 22 along the rotational axis R, and in so doing entrain the dry ice snow T located in the respective expansion chamber 13 and accelerate it via the Laval nozzle 40.

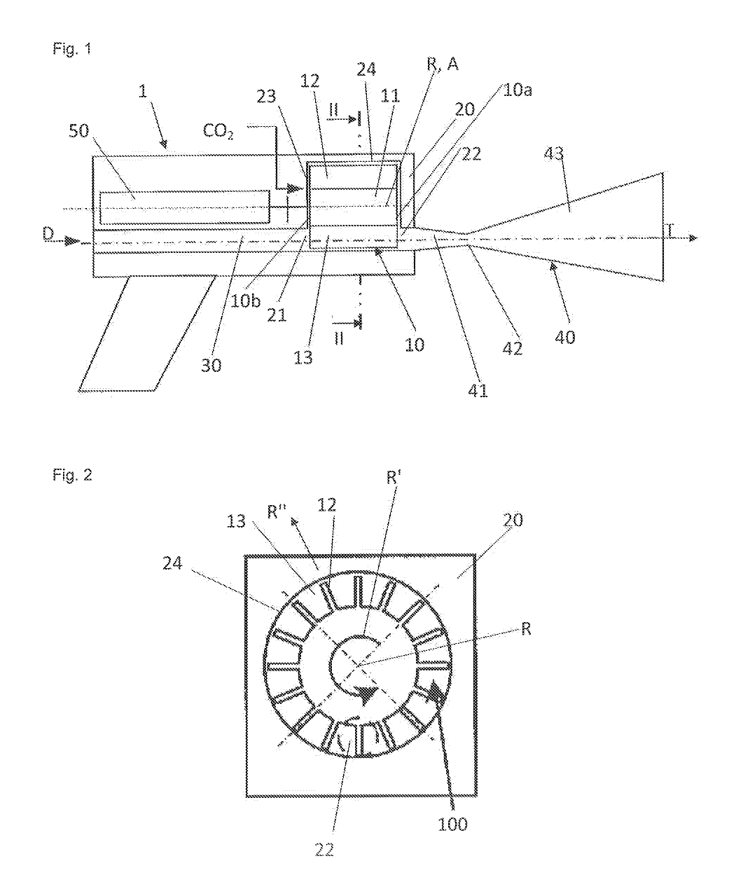

On FIG. 2, the liquid carbon dioxide is basically axially introduced via an inlet opening 23 into the expansion chambers 13 rotating by in such a way that the liquid carbon dioxide or dry ice snow T arising from it rotates with the rotating body 10 to nearly complete a full revolution, until the compressed air stream D ejects it out of the outlet opening 21. Preferably involved here is at least half a revolution by the rotating chamber 10, in particular three fourths of a revolution by the rotating chamber 10.

It is further also possible to introduce the liquid carbon dioxide into the rotating body 10 with a tangential component relative to the circumference of the rotating body 10, so that the pulse of the liquid carbon dioxide can be utilized to additionally drive the rotating body or support a rotation by the rotating body 10 around the rotational axis R.

Tests have shown that dry ice snow packets T large enough to clean a surface are routinely only generated at low speeds. The latter preferably range between 20 and 200 revolutions per minute, with between 40 and 100 revolutions per minute being especially preferred. As a rule, even lower speeds result in an uneven cleaning of the surface. Higher speeds cause less CO₂ to be supplied per expansion chamber 13 given the same CO₂ consumption. The wings 12 of the rotating body 10 then also push less snow forward, and inadequately compact it. While the effect is a very uniform particle stream, it does not translate into any significantly improved cleaning effect by comparison to CO₂ snow nozzles without a rotating body 10. The CO₂ supply could be elevated so as to increase the load per expansion chamber 10 and compaction, but economic efficiency would suffer as a result. In addition, too high a production of snow increases the risk that the rotating body 10 will become blocked.

Experience shows that the best cleaning results are achieved when the expansion chambers are loaded with liquid CO₂ at a level of between 0.05 to 1.0 g/cm³, preferably 0.1 to 0.7 g/cm³, and especially preferably 0.2 to 0.4 g/cm³.

The preferred outer diameter of the rotating body 10 ranges from 20 to 100 mm. For example, the rotating body 10 can be driven by a compressed air motor 50, since the latter has a good overall size-to-torque ratio. As a rule, commercially available compressed air motors 50 have nominal speeds in excess of 200 revolutions per minute, but they can be reduced by means of a transmission in the form of a reduction gear (see FIG. 4), for example, wherein this simultaneously makes it possible to increase the torque, thereby enhancing immunity to blockades resulting from high braking torques.

Alternatively, an electric motor 50 can be used (see FIGS. 1, 3 and 5), the speed of which is monitored by a rotation sensor, for example, and can be controlled via the current intensity. It is further conceivable that the rotating bodies 10 be driven by the compressed air stream D used for acceleration, similarly to a turbine. The compressed air stream D or a portion thereof here drives a turbine, which drives the rotating body 10 directly or via a reduction gear. In like manner, the rotating body can itself act as a turbine by slanting the wings 12, and be driven by the compressed air stream D. The benefit is that this eliminates the need for a potential additional motor 50, bringing with it weight and cost-related advantages.

Despite the use of a motor 50, it is also possible to slightly incline the wings 12 of the rotating body 10 in relation to the rotational axis R, so as to in this way either minimize the flow resistance in the compressed air stream D or—conversely—support the motor 50 by generating an additional torque.

The present invention advantageously enables the cleaning of surfaces with larger dry ice packets T, the size of which is limited by the expansion chambers 13 or their volume. The size of the producible dry ice packets T generated out of the CO₂ liquid phase yields a comparatively broad range of applications, e.g., the cleaning of conveyor belts, transport containers, machinery, motors, trains, etc.

### REFERENCE NUMBERS

| | |
|---|---|
| 1 | Device for generating dry ice snow |
| 10 | Rotating body |
| 10a | Second side or front side |
| 10b | First side or rear side |
| 11 | Hub shells |
| 12 | Wings |
| 13 | Expansion chamber |
| 20 | Housing |
| 21 | Inlet opening |
| 22 | Outlet opening |
| 23 | Inlet opening |
| 24 | Continuous wall |
| 30 | Channel |
| 31 | Additional channel |
| 40 | Laval nozzle |
| 41 | First nozzle section |
| 42 | Nozzle neck |
| 43 | Second nozzle section |
| 50 | Motor |
| 51 | Transmission or reduction gear |
| A | Drive axle |
| R | Rotational axis |
| R′ | Rotational direction |
| R″ | Radial direction |
| D | Gaseous mass flow (e.g., compressed air) |
| T | Dry ice snow or dry ice snow packets |

What I claim is:

1. A device for generating dry ice snow comprising a rotating body mounted in a housing so that it can rotate around a rotational axis, wherein the rotating body exhibits at least one expansion chamber on the circumference of the rotating body, a feed line for introducing liquid carbon dioxide into the at least one expansion chamber, an inlet opening of the housing for introducing a gaseous mass flow into the at least one expansion chamber, and an outlet opening of the housing for dispensing the dry ice snow generated in the at least one expansion chamber from the housing, characterized in that
the at least one expansion chamber extends along the rotational axis, and that the inlet opening and outlet opening are arranged in such a way that the at least one expansion chamber can be simultaneously connected with the inlet opening and outlet opening in terms of flow by rotating the rotating body around the rotational axis, so that at least sections of the at least one expansion chamber can carry a gaseous mass flow introduced through the inlet opening along the rotational axis.

2. The device according to claim 1, characterized in that the device exhibits several expansion chamber partitioned from each other.

3. The device according to claim 1, characterized in that the inlet opening and outlet opening are arranged in such a way that the at least one expansion chamber or each expansion chamber is simultaneously connected in terms of flow with the inlet opening and outlet opening once per revolution by the rotating body around the rotational axis.

4. The device according to claim 1, characterized in that the device exhibits a channel connected in terms of flow with the inlet opening for supplying the gaseous mass flow, wherein at least one section of the channel exhibiting the inlet opening or the entire channel extends along the rotational axis, parallel to the rotational axis.

5. The device according to claim 1, characterized in that the at least one expansion chamber or the several expansion chambers taper along the rotational axis, toward the outlet opening, wherein the rotating body or a hub shell of the rotating body is designed like a cone or truncated cone.

6. The device according to claim 1, characterized in that the device for dispensing the dry ice snow exhibits a Laval nozzle, wherein the Laval nozzle is connected in terms of flow with the outlet opening, or wherein at least sections of the Laval nozzle are formed by the expansion chamber connected in terms of flow with the outlet opening and a nozzle section that adjoins at least one outlet opening.

7. The device according to claim 4, characterized in that the channel branches from another channel of the device that extends along the rotational axis, wherein the outlet opening empties into the additional channel, and wherein the additional channel empties into said Laval nozzle.

8. The device according to claim 1, characterized in that the device exhibits a motor for rotating the rotating body around the rotational axis.

9. The device according to claim 8, characterized in that the motor is designed as a compressed air motor, which is coupled via a gear reduction with a drive axle of the rotating body.

10. The device according to claim 8, characterized in that the motor is designed as an electric motor.

11. The device according to claim 1, characterized in that the device is designed to be driven by the same gaseous mass flow also used to accelerate the generated dry ice snow, wherein the device for driving the rotating body with said mass flow exhibits a turbine coupled with a drive axle of the rotating body, wherein the turbine is coupled with the drive axle of the rotating body either directly or via a reduction gear.

12. The device according to claim 1, characterized in that the at least one expansion chamber or the several expansion chambers of the rotating body are bordered by wings, which project in a radial direction from a hub body of the rotating body, wherein the wings are gas permeable or gas impermeable in design, and wherein the wings are inclined relative to the rotational axis, so that the rotating body can be driven by the gaseous mass flow, or the motor of the device can be supported by the gaseous mass flow as it passes through the at least one expansion chamber or one of the several expansion chambers along the rotational axis, at least in sections.

13. The device according to claim 1, characterized in that the feed line for the liquid CO₂ is connected in terms of flow with at least one inlet opening of the housing, which is situated in such a way that the at least one expansion chamber or each of the expansion chambers can be connected in terms of flow with the at least one inlet opening by rotating the rotating body around the rotational axis, once per revolution by the rotating body around the rotational axis, so that liquid CO₂ can be introduced into the respective expansion chamber, wherein the at least one inlet opening is arranged in such a way that liquid CO₂ introduced into the respective expansion chamber for generating dry ice snow can remain in the respective expansion chamber for at least half a revolution by the rotating body before being dispensed from the expansion chamber through the outlet opening.

14. The device according to claim 13, characterized in that the feed line and at least one inlet opening are preferably configured in such a way that liquid CO₂ can be introduced in a streaming direction into the respective expansion chamber connected in terms of flow with the inlet opening, wherein the streaming direction runs along the rotational axis, especially parallel to the rotational axis, or exhibits a component transverse to the rotational axis, so that the rotating body can additionally be driven by the liquid CO₂.

15. The device according to claim 1, characterized in that the gaseous mass flow is compressed air.

16. The device according to claim 13, characterized in that wherein the at least one inlet opening is arranged in such a way that liquid CO₂ introduced into the respective expansion chamber for generating dry ice snow can remain in the respective expansion chamber for at least for three fourths of a revolution by the rotating body.

17. A method for generating dry ice snow using a device comprising a rotating body mounted in a housing so that it can rotate around a rotational axis, wherein the rotating body exhibits at least one expansion chamber on the circumference of the rotating body, a feed line for introducing liquid carbon dioxide into the at least one expansion chamber, an inlet opening of the housing for introducing a gaseous mass flow into the at least one expansion chamber, and an outlet opening of the housing for dispensing the dry ice snow generated in the at least one expansion chamber from the housing, characterized in that
the liquid carbon dioxide is introduced into at least one expansion chamber of a rotating body and expands in the process, so that dry ice snow is generated in the at least one rotation chamber, wherein the at least one rotating body is rotated around a rotational axis, and wherein the at least one expansion chamber is arranged on the circumference of the rotating body, and extends continuously along the rotational axis, and wherein a gaseous mass flow is introduced into the at least one rotation chamber, in the form of compressed air, so that the mass flow streams through the at least one expansion chamber at least in sections along the rotational axis, during which the dry ice snow generated in the at least one expansion chamber is entrained and ejected out of the at least one expansion chamber along the rotational axis, onto a surface to be cleaned.
